(19) United States
(12) Patent Application Publication
(10) Pub. No.: US 2015/0294387 A1
(43) Pub. Date: Oct. 15, 2015

(54) METHOD AND SYSTEM OF FACILITATING SHOPPING THROUGH A HANDHELD DEVICE AND MOBILE NETWORK

(71) Applicants: Elizabeth Karmazyn, Toronto (CA); Ariell Gertel, Toronto (CA)

(72) Inventors: Elizabeth Karmazyn, Toronto (CA); Ariell Gertel, Toronto (CA)

(21) Appl. No.: 14/685,318

(22) Filed: Apr. 13, 2015

(30) Foreign Application Priority Data
Apr. 14, 2014 (CA) 2849217

(51) Int. Cl. G06Q 30/06; G06Q 30/02

(52) U.S. Cl. CPC G06Q 30/0623; G06Q 30/0641; G06Q 30/0631; G06Q 30/0281

(57) ABSTRACT

The present disclosure relates to a system to allow for a direct customer/retail integrated communication activated through a product barcode scan on a handheld device such as a smartphone that will display item specific details, stock availability and automatically suggest alternate, upgraded, add-ons or other coordinating items/products on the handheld device.

### TECHNICAL FIELD

This disclosure generally relates to a method and apparatus (collectively a system) of enhancing the retail shopping experience by enabling a customer in-store to view and select via their handheld mobile device such as a mobile phone or tablet a first item and then automatically view additional items identified by the retailer as potential related items.

### BACKGROUND

‘Up-selling’ is a sales technique designed to increase the sales invoice. Up-selling involves promoting more additional items, upgrades and/or add-ons to customers that are extra purchases and increase sales. It's a business concept that requires sales people to not be simply order takers, but instead be active sellers.

The current retail model relies on the effective training of sales staff to facilitate ‘up-selling’ and propel sales to increase the inventory efficiency ratio of the retailer. This sales model presents multiple negative variables—
1. The retailer is dependent on their training methods.
2. The retailer is dependent on the ability of the staff selected to retain the information taught during training
3. The retailer is dependent on the individual skill-set of sales staff to effectively sell to the consumer.
4. The retailer is dependent on the day-to-day mood of the individual sales staff and their overall motivation to sell in the store. Tracking the sales of each staff member is one method employed to judge personal skill and motivation at work, however staff, whom are either unskilled or unmotivated, frequently sell enough merchandise to meet the absolute minimum requirement to retain their job, and do not strive for increased sales.

There is a need for a system that eliminates the above variables, imparting efficient sales techniques to the consumer that are created, directed and implemented at a corporate level, and communicated directly to the consumer within the retail location, and in real-time within the bricks and mortar retail location.

One current practice is for retailers to create online catalogues or in the fashion sector, ‘look books’ displaying the ideal way to coordinate items, or possible add-on purchases to the original product of interest. However, ‘look books’ for example prove to be inefficient since they are photos of items that coordinate without providing the ability to interact in-store. ‘Look books’ are presently located on online retail sites and through retail applications that are seldom used in-store—the consumer opts to physically look for matching items and ask for sales assistance, rather than open the retail application.

There is a need for a system that draws from the established practice of ‘styling’ and that will facilitate in-store communication.

Retailers are seeking ways to draw customers away from their computers and the online shopping world into integrated interactive shopping, but have yet to uncover a cohesive model to enable the symbiotic process of combining technology with the real-time, brick and mortar shopping experience.

There is a need for a system that will permit consumers while in-store to obtain detailed product information, provide fast easy payment and/or suggest alternate, upgrade or add-on products without the need of sales staff and to assist with the ease, efficiency and enjoyment of the overall shopping experience.

### SUMMARY

The present disclosure provides a method and apparatus (collectively a system) to allow for a direct customer/retail integrated communication activated through a product barcode scan on a handheld device such as a smartphone that will display item specific details, stock availability and automatically suggest alternate, upgraded, add-ons or other coordinating items/products on the handheld device.

In an embodiment the system further may facilitate faster customer service using an in-store sales assistance notification.

In another embodiment the system may further provide an in-application payment method with a secure customer account.

In another embodiment the disclosure provides a system to allow for a direct customer/retail integrated communication, the system comprising a handheld mobile computing and communication device, at least one retail store computer system capable of communicating with said handheld mobile computing and communication device, said handheld mobile computing and communication device having a graphic user interface display, scanner capability, a programmed computer processing means and means to communicate with the at least one retail store computer system, means activated through a product barcode scan on the handheld mobile computing and communication device, wherein the barcode scan is transmitted from the handheld mobile computing and communication device to the at least one retail store computer system and the at least one retail store computer system identifies and transmits to the handheld mobile computing and communication device photos, detailed product information and a plurality of alternate, upgraded, add-on and/or coordinating products, and wherein the photos, detailed product information and a plurality of alternate, upgraded, add-on and/or coordinating products are displayed graphic user interface display.

In another aspect the present disclosure relates to a method to allow for a direct customer/retail integrated communication, the method comprising providing software for download on a handheld mobile computing and communication device, said handheld mobile computing and communication device having a graphic user interface display, scanner capability, a programmed computer processing means and means to communicate with at least one retail store computer system, scanning a product barcode scan on the handheld mobile computing and communication device, transmitting the barcode scan from the handheld mobile computing and communication device to a retail store computer system, the retail store computer system identifying and transmitting to the handheld mobile computing and communication device photos, detailed product information and a plurality of alternate, upgraded, add-on and/or coordinating products, displaying the photos, detailed product information and a plurality of alternate, upgraded, add-on and/or coordinating products on the handheld device graphic user interface display.

A further aspect the present disclosure relates to a non-transitory computer readable storage medium having program instructions stored thereon for scanning a product barcode scan, transmitting the barcode scan from a handheld mobile computing and communication device to a retail store computer system, receiving from the retail store computer system photos, detailed product information and a plurality of alternate, upgraded, add-on and/or coordinating products, for displaying the photos, detailed product information and a plurality of alternate, upgraded, add-on and/or coordinating products on a graphic user interface display.

These and other features and advantages of the present disclosure will become apparent from the following detailed description of illustrative embodiments, which is to be read in connection with the accompanying drawings.

### BRIEF DESCRIPTION OF THE DRAWINGS

In order that the disclosure may be further understood, embodiments thereof will now be described by way of example, with reference to the accompanying drawings, in which:

FIG. 1 is an example of a prior art ‘LOOK BOOK’ format.

FIG. 2 is a schematic architecture of an exemplary system for carrying out an embodiment of the presently disclosed system.

FIG. 3 is a data flow diagram depicting steps according to an embodiment of the presently disclosed system.

FIG. 4 is a data flow diagram depicting steps according to another embodiment of the presently disclosed system.

FIG. 5 is a data flow diagram depicting steps according to another embodiment of the presently disclosed system.

FIG. 6 is a data flow diagram depicting steps according to another embodiment of the presently disclosed system.

FIG. 7 is a representative screen shot of a HOME SCREEN with a mutable center frame for retail name/logo according to an embodiment of the presently disclosed system.

FIG. 8 is a representative screen shot of a REGISTRATION SCREEN with a language setting drop down menu according to an embodiment of the presently disclosed system.

FIG. 9 is a representative screen shot of a BARCODE SCAN SCREEN according to an embodiment of the presently disclosed system.

FIG. 10 is a representative screen shot of an ITEM SCREEN with scroll enabled curated item screens according to an embodiment of the presently disclosed system.

FIG. 11 is a representative screen shot of an ITEM DESCRIPTION SCREEN for the ITEM SCREEN of FIG. 10 according to an embodiment of the presently disclosed system.

FIG. 12 is a representative screen shot of a SALES ASSISTANCE/HELP LOCATOR SCREEN with an email notification feature according to an embodiment of the presently disclosed system.

FIG. 13 is a representative screen shot of a SECOND ITEM SCREEN selected from one of the curated item screens of FIG. 10 according to an embodiment of the presently disclosed system.

FIG. 14 is another example of a representative screen shot of a SECOND ITEM SCREEN selected from one of the curated item screens of FIG. 10 and having an expandable ‘Favorites’ and ‘Social Media Icons’ according to an embodiment of the presently disclosed system.

FIG. 15 is a representative screen shot of a THIRD ITEM SCREEN selected from another of the curated item screens of FIG. 13 or 14 according to an embodiment of the presently disclosed system.

FIG. 16 is a representative screen shot showing list of saved items in ‘Favorites’ Feature with ‘Account’, ‘Language’, ‘Settings’ and ‘Terms & Conditions” buttons below according to an embodiment of the presently disclosed system.

FIG. 17 is a representative screen shot of an ITEMIZED LIST OF PURCHASES SCREEN with ‘Purchase’ and ‘Cancel’ buttons according to an embodiment of the presently disclosed system.

FIG. 18 is a representative screen shot of a FINAL RECEIPT AND PAYMENT SCREEN with Authorization Code & Barcode according to an embodiment of the presently disclosed system.

FIG. 19 is a representative screen shot of an END OF SALE SCREEN according to an embodiment of the presently disclosed system.

The features and advantages of the present disclosure will become more apparent from the detailed description set forth below when taken in conjunction with the drawings, in which like reference characters identify corresponding elements throughout. In the drawings like reference numbers generally indicate identical, functionally similar and/or structurally similar elements.

### DETAILED DESCRIPTION

The description which follows and the embodiments described therein are provided by way of illustration of an example or examples of particular embodiments of principles and aspects of the disclosed system. These examples are provided for the purposes of explanation and not of limitation of those principles and of the disclosed system.

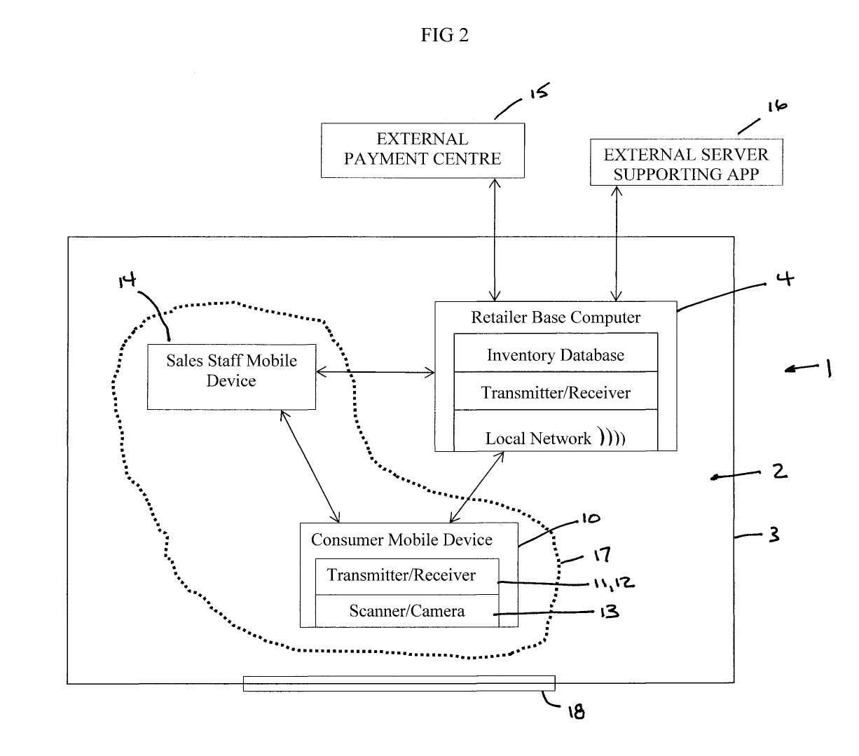

Referring to FIG. 2, an embodiment of a method and apparatus (collectively a system) 1 to allow for a direct customer/retail integrated communication, activated through a product barcode scan on a handheld device such as a smartphone that will display item specific details, stock availability and automatically suggest alternate, upgraded, add-ons or other coordinating items/products on the handheld device is depicted.

As depicted in FIG. 2 a bricks and mortar retail location 2 has a signal perimeter 3 for its local area network. The Retailer Base Computer 4 connected to the local area network contains a database of product information with corresponding barcodes and has the software associated with the present disclosure downloaded to it.

A consumer mobile device 10 having a transmitter/receiver 11,12 and scanner/camera 13 capability, on passing the signal perimeter 3, such as on entering the retail location through doors 18 is prompted to connect to the local area network with an Auto Login or Register a perimeter signal code received over the Local Area Network. Once connected to the local area network and login the consumer mobile device 10 can communicate to a Sales Staff Mobile Device 14 within a defined proximity field 17 or the Retailer Base Computer 4.

The Retailer Base Computer 4 is connectable to an External Payment Centre 15 such as a bank or credit card company when the consumer is ready to make a purchase as described herein. The Retailer Base Computer 4 is also connectable to an External Server 16 supporting the software associated with the present disclosure.

The interface of the presently disclosed system is used for direct consumer-retailer communication to create an interactive shopping experience that utilizes, in the embodiments described, four technological modules: 1. Mobile Device Payment—2. Global Positioning—3. Coordinated View Controllers—4. Barcode Scanner.

The presently disclosed system is intended to available for multiple operating systems such as iOS and Android devices.

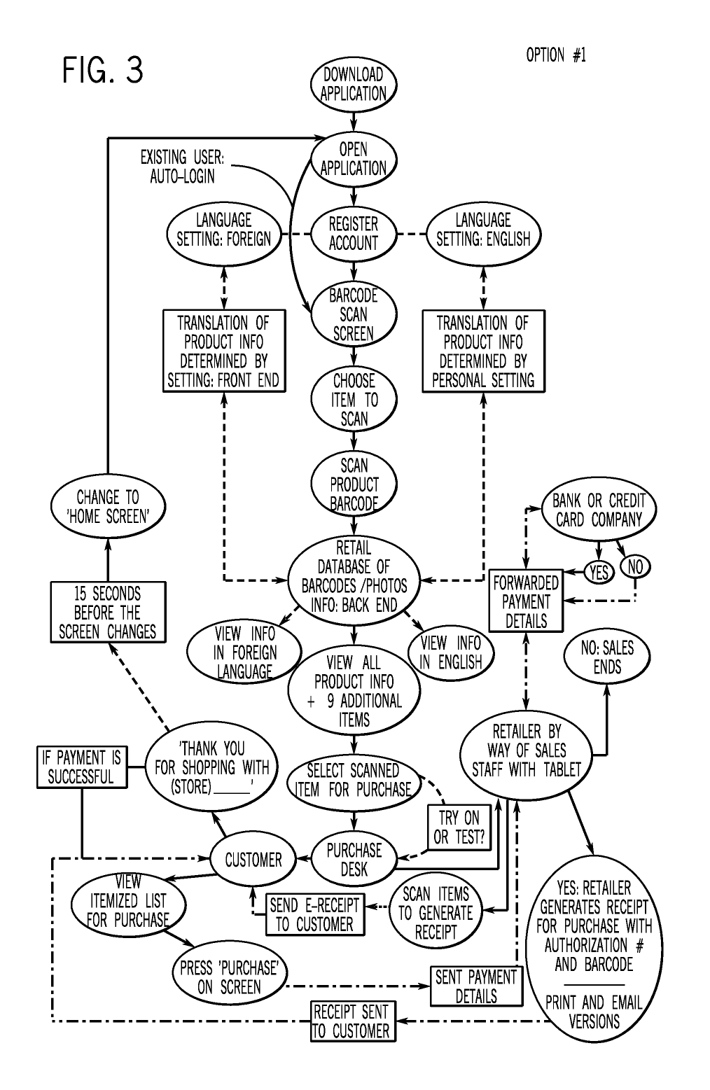

FIGS. 3-6 are data flow diagrams illustrating different options for the method of the disclosed system.

FIG. 3 illustrates one embodiment of a method for the disclosed system. Initially at 30 the consumer downloads the mobile application (the “app”) to their handheld device using conventional methods to do so such as access to the App Store or as noted earlier on being prompted to do so by a signal received on entering a retail location such as a department store or retail mall. When the app is opened for the first time the user is requested to register at 32 and create an account (see FIG. 8). While creating an account the user sets the language, inputs name, contact and address information as well as credit or debit card info. The other features as outlined herein, and functionality of the app are not dependent on the input of credit or debit card info and can be used independently of the mobile device payment method feature. The user can select the app to translate product information from the source language to the language desired as set by the user during the initial registration. In FIGS. 3-6 the following Legend is used to depict the information and data flow:
Circle=Visible step in the process
Square=Hidden step in the process
Solid Line w/ Arrow=Direct pathway in the process
Hashed Line w/ Arrow=Hidden pathway in the process
Dotted Line w/ Arrow=‘Communication’ using the Interface pathway in the process
∞ (Infinity Symbol)=Depicts Looped or Cyclical pathway in the process

As a retail efficiency application, the presently disclosed system allows retailers to direct customer traffic through the brick and mortar location to multiple departments (or in the case of a mall to multiple stores within the mall), transforming a single transaction visit into a multiple transaction visit by displaying a constant cycle of inventory. The cycle of inventory is based upon the initial barcode scan by the customer upon entering the retail location, originating from the barcode belonging to the first item of interest.

A curated selection of similar and complementary items from different departments within the store is then immediately displayed on the handheld device for the customer to view photos, information such as brand, size, colour etc., product availability and in-store inventory. The initial scan of an item barcode upon entering the retail location quickly and conveniently opens the entire virtual store for viewing, thus merging the in-store shopping experience with the convenience and efficiency of the broader virtual shopping experience.

This enables the retailer to guide consumers to more areas of the ‘retail floor’ within a single in-store visit in order to increase the time spent within the location, and to advertise and sell further items (up-sell) based upon the initial barcode scan to increase the number of purchases within a visit. The retailer is also able to better control the inventory turnover and conversion ratios by directing consumer traffic to products/items that require added attention and assistance to increase the turnover ratio, inventory efficiency and overall sales. The data gathered through the use of the presently disclosed system via its interface, barcode scan and in-application, in-store payment process will provide invaluable information on consumer inventory preferences, shopping habits, trends in shifting consumer tastes and advanced predictors of product increase and/or decline.

The presently disclosed system depicted using a handheld device in the form of a smartphone application empowers the consumer with product information, a greater knowledge of available in-store items, the ability to ‘self-serve’ using the curated list of items provided, a more efficient use of shopping time through the curated lists, in-application payment method and in-store customer service notification. The presently disclosed system creates customization of the in-store shopping experience centered on the initial item scanned upon entering the store, and a merger of mobile technology with the brick and mortar retail sector.

Within the in-store retail environment, The presently disclosed system may provide consumers with a list of alternate, upgraded, add-on and/or coordinating products based upon their initial barcode scan, opening a large inventory of products available in-store through a cycle of alternate, upgraded, add-on and/or coordinating items, in turn allowing the consumer to shop in person and in real-time as they do virtually.

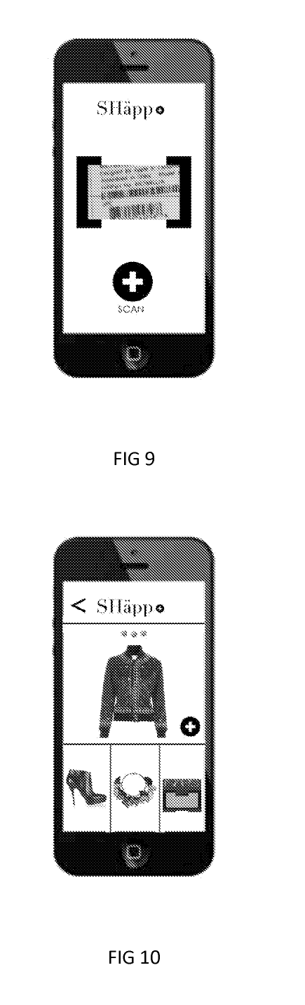

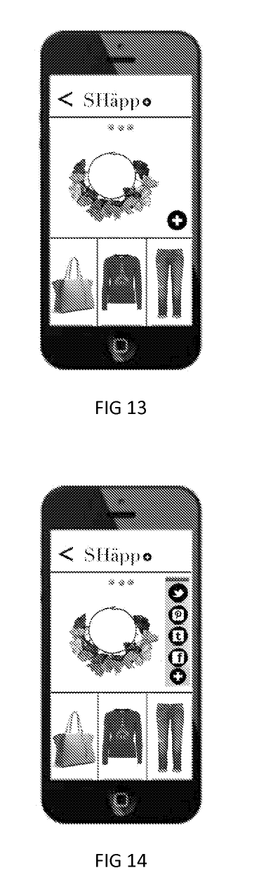

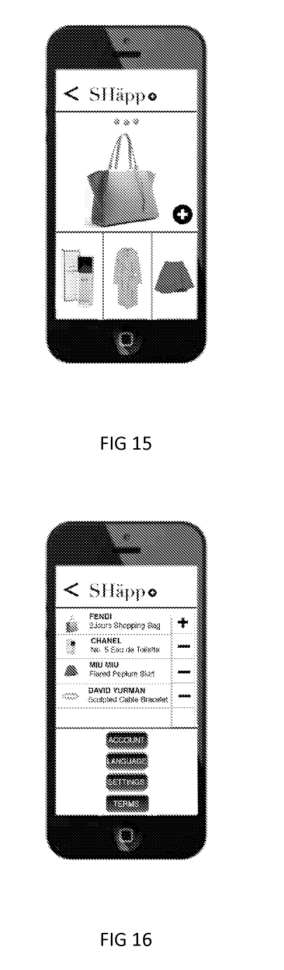

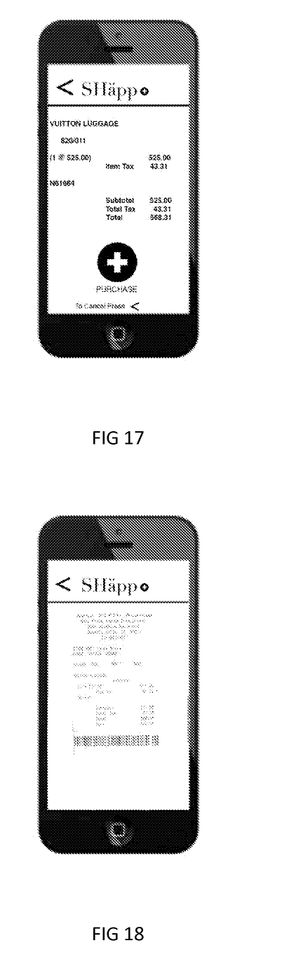

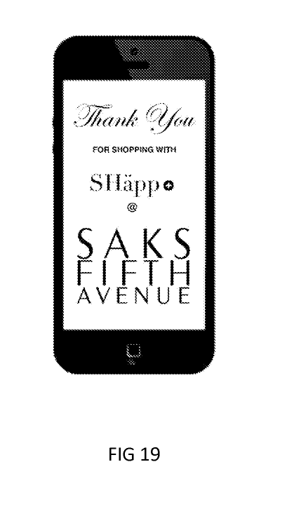

The next step in the method depicted in FIG. 3 at 34 is on entry into the retail store the user is prompted to scan a barcode associated with an item of interest (see FIG. 9). The user at 36, 38 choses an item of interest and scans the barcode using the camera function on the handheld device. The app wirelessly links the consumer's handheld mobile device either with a Wi-Fi, Bluetooth, cellular or other communication technology with the retail store computer system and its inventory database. The retail store computer system transmits to the consumer's handheld device at 40, photos, detailed product information and a plurality of alternate, upgraded, add-on and/or coordinating products (in the embodiment illustrated nine additional items are displayed) of the item scanned, shown in a single screen view below based upon age, gender and/or category as pre-defined by the retailers' team of merchandisers, buyers and/or stylists (see FIG. 10). In the embodiment depicted the additional items are displayed in groups of three. Selecting one of the alternate, upgraded, add-on and/or coordinating products then displays (see FIG. 13) a new photo, detailed product information and a new, refreshed curated list of a plurality of alternate, upgraded, add-on and/or coordinating items based upon age, gender and/or category as pre-defined by the retailers' team of merchandisers, buyers and/or stylists. In the embodiment depicted nine additional items are displayed.

The presently disclosed system in further embodiments allows the consumer to communicate directly with the retailer for in-store customer service and payment process. Using an in-store locating feature (see FIG. 12), activated and deactivated upon entering and exiting the store, the consumer can call upon immediate sales assistance with the simple press of a button on their mobile device. For privacy purposes, this feature can be disabled without affecting the communication model, or other features of the disclosed system. The customer has the ability depicted (at 42 in FIG. 3) to purchase items in-store using the interface, allowing their mobile device to effectively ‘communicate’ payment in real time via a credit or debit card number stored within a secure, password protected customer account directly to the sales associate while standing at the cashiers desk using strictly mobile devices—smartphone and tablet.

In FIG. 3 the retail staff at 44 can indicate whether the sale is ended or is to proceed. If proceeding see steps 46-56 in FIG. 3 with payment sent wirelessly to the Bank or Credit Card company. Once payment has been sent through the smartphone, the retailer receives an individual authorization code accompanied by a unique barcode from the bank/credit card company to be used by the sales associate to confirm that payment has been received (see FIG. 18). The barcode and authorization code are used to generate an itemized receipt (showing the unique barcode and authorization number) for the transaction, one that will be printed as hard copy and emailed to the customer through the email account registered to their secure account. The transaction continues with wrapping and the customer is able to exit the store with their purchases in-hand.

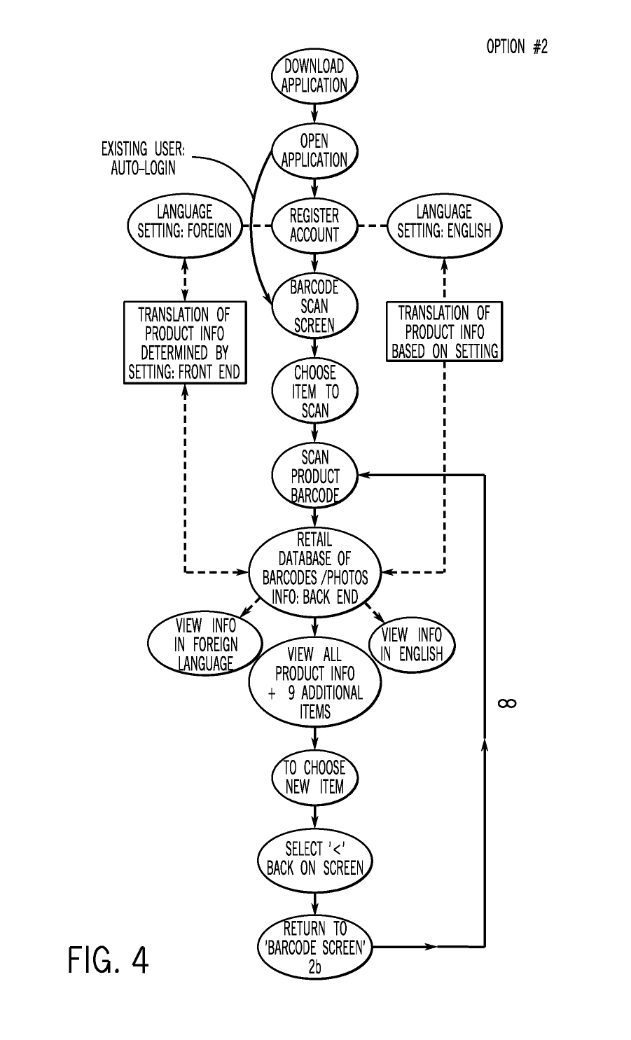

In FIG. 4 a variation on the method of FIG. 3 is depicted. In FIG. 4 the consumer elects after viewing the product info for a first item, to choose a new item at 70 go back to the barcode screen 38 and scan a new item. The process of FIG. 3 steps 38-40 is repeated for the new item.

The presently disclosed system may function as a ‘retail efficiency application’, facilitating a greater and more direct communication between the consumer and retailer, increasing the speed and efficiency of brick and mortar retail shopping to lead to higher overall sales, further store and product branding using Social Media via the consumer, and effectively integrate real-time and virtual shopping experiences.

The presently disclosed system may incorporate the following features.

Personal Shopper/Self-Serve—A virtual sales associate in the palm of your hand providing you with detailed product information, stock availability and items that are chosen and curated by the retailer to accompany the product that you have selected.

Example One: A female customer enters a large, upscale department store. The software application of the presently disclosed system, once downloaded to the consumer's handheld mobile device, will be enabled and ready to use upon entering the store. The customer may have an event to attend and is looking for an outfit. She scans the barcode of a black cocktail dress that she likes using the disclosed system. The screen on her mobile device now displays a photo of the black cocktail dress, available in-store sizes and quantities, other available colours, and directly below a plurality of alternate, upgraded, add-on and/or coordinating items—in the embodiment depicted nine additional items displayed three at a time—a gold handbag, black high-heels and a pair of earrings as an example—three items from three different departments. She likes the gold handbag, so touches the photo to obtain more information on the item. Her screen now displays a photo of the gold handbag, product information, and a newly curated list of a plurality of alternate, upgraded, add-on and/or coordinating items coordinating items.

Example Two: A customer enters a big-box electronics store for the purpose of buying a new television. The software application of the presently disclosed system, once downloaded to the consumer's handheld mobile device, will be enabled and ready to use upon entering the store. The customer finds a television that they like, and so scans the barcode to obtain more detailed information. The screen on the customer's mobile device now displays the television scanned, detailed product information, and below a plurality of alternate, upgraded, add-on and/or coordinating items that have been curated to accompany the television such as a PlayStation game console, a Samsung home theater system, a television wall-mount bracket, a BluRay player, and the BluRay DVD of a popular film.

Another feature of the disclosed system is Barcode Scan—Using the existing camera function in handheld mobile devices such as smartphone devices, the customer aims and aligns the red line of the scanner with the existing barcode standard on products, and touches the ‘Scan’ button. Using a database of all products and their corresponding barcodes and detailed product information, the disclosed system displays on the consumer's handheld mobile device the information for the barcode scanned in a newly generated display screen.

In embodiments of the disclosed system a Payment Interface Module can be provided. The module allows the customer's mobile device to communicate directly with the operating system of the retail location such as to tablets or payment devices to purchase merchandise in-store using their mobile device and a pre-programmed credit or debit card number available through a secure login account. (The other features of the system are functional and the customer may choose an alternate payment method). Upon entering the store the system downloaded to the consumer's handheld device is enabled—auto-login may be the default setting to enable the customer to take full advantage of the feature of the system permitting a payment interface. The payment module is as follows:
A. Retailer scans all items of the sale, and ‘sends’ a screen view of the receipt to the customer standing in front of them via their mobile device.
B. Customer is now able to view their bill on their mobile device, and confirm that it is correct before ‘sending’ payment.
C. Customer ‘sends’ payment information to the sales associate (in front, at the cashier's desk) through their secure account and the pre-programmed credit/debit card number.
D. The payment information is sent to the bank/credit card company by the retailer to confirm that the purchase can be made successfully.
E. Once the amount is confirmed by the bank/credit card company, a barcode and authorization number are ‘sent’ to the retailer, initiating the automatic creation of a receipt that is both printed and emailed to the customer (to the email account registered with their account).

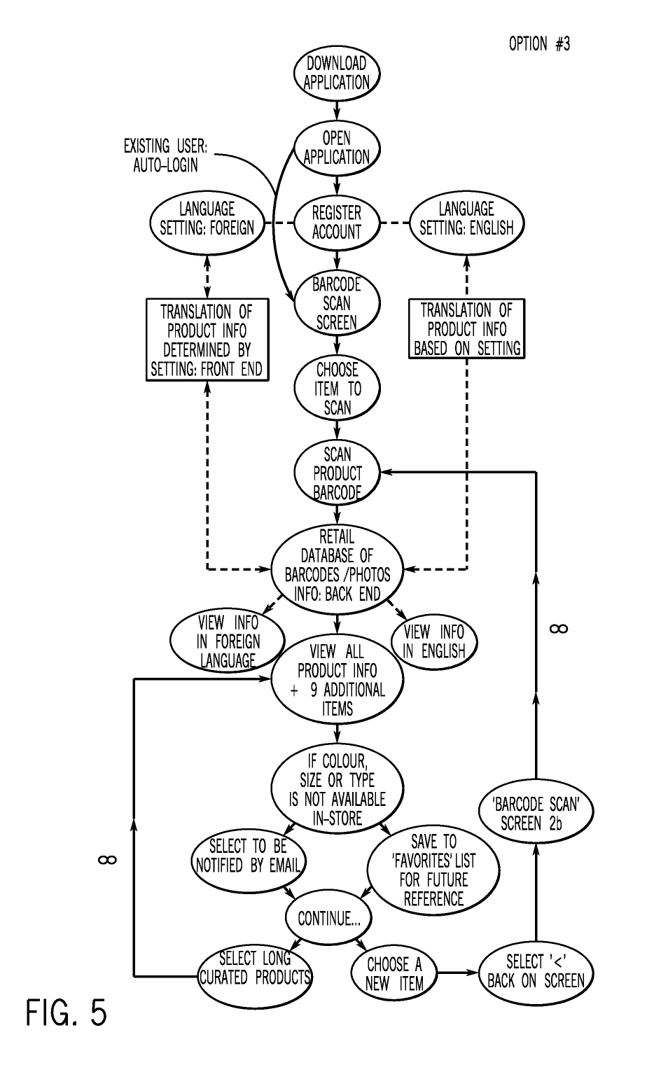

A further feature of the system is Product Information. The system enables the consumer to access detailed product information such as available sizes, colours, in-store inventory to create a faster and more efficient shopping experience, bypassing the sales associates who would require the customer to wait while they check availability. As shown in FIG. 5 should an item not be available in store, the customer has the ability to be notified via email when it is in-stock at multiple store locations using the email address entered upon initial registration. Auto-login enables the customer to be notified to the email address registered to their account.

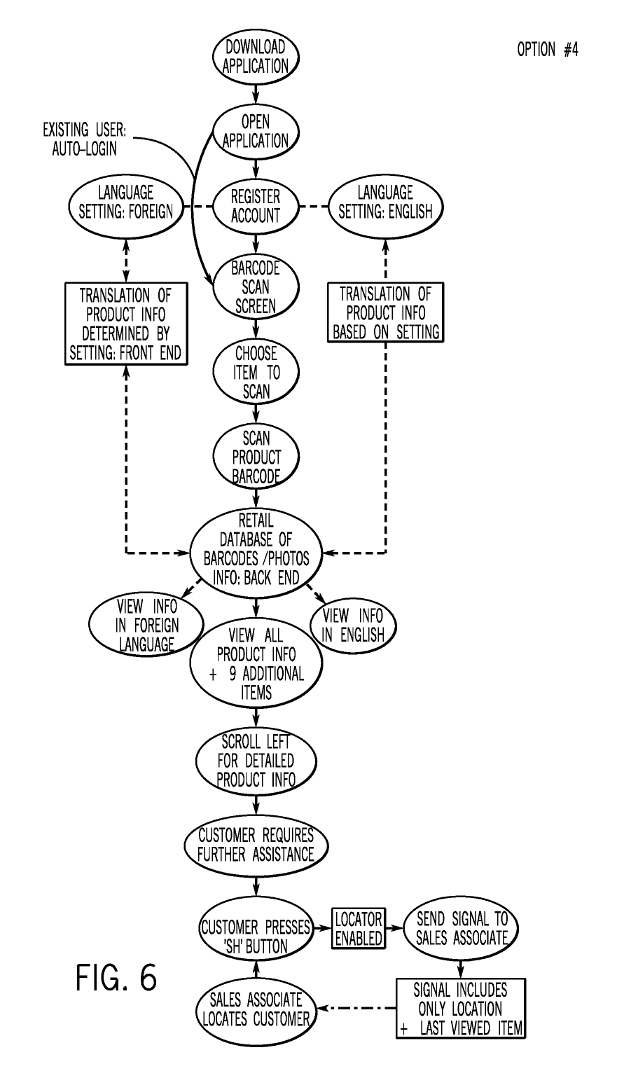

Customer Service Locater—This feature as shown in FIG. 6 within the system provides the consumer the ability to access immediate sales assistance using an in-store locater that is enabled upon entering the retail location and disabled upon exiting. With the touch of a button (see FIG. 12), the customer can signal sales staff (through their personal tablets) that they require further assistance. This feature sends two pieces of information only to the sales associates: 1. The location of the customer in-store, and 2. The last item viewed when the locator button is touched by the customer. * The customer can choose to enable or disable this function to customize their shopping experience.

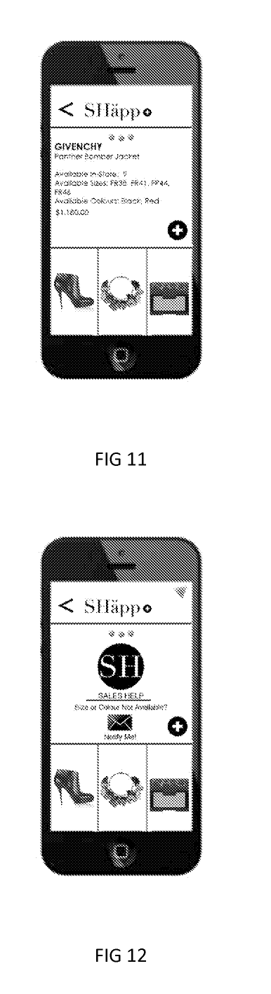

Language—Using the ‘Language’ feature within the system, the customer is able to customize their shopping experience according to their preferred language, set during the registration of an account, and adjustable in the ‘Settings’ area of the system [FIG. 8]. This feature translates the detailed product information of an item [FIG. 11] to a foreign language or English (the default setting). The translation is performed on the front-end of the system, as an interceptor between the retailer and consumer. Each retailer will input product information in the language of the retail location, to be translated according to the customer using the system.

Example. An English-speaking consumer in Japan scans an item barcode in a participating retail store. The retailer has inputted the detailed product information in Japanese (their native language). The system translates the information ‘sent’ through the communication interface to the English-speaking customers' mobile device in English—according to their preferred language setting.

Example. A Chinese consumer in the United States scans the barcode of an item in a participating retail location. The retailer has inputted the detailed product information in English, as per the geographical location of the retail store. The system translates the English information into Mandarin or Cantonese automatically according to the consumers' preferred language setting, prior to being displayed on their mobile device.

Favorites—The consumer has the ability to save any item viewed to their personal ‘Favorites’ for easy future reference, and quick in-store purchase when they return, and to share the items in their ‘Favorites’ list on any Social Media platform using the available icons. Examples include, but are not limited to, Facebook, Twitter, Pintrest, Instagram, and Tumblr (see FIG. 14)

Integrated Advertising—The curated product lists enable the retailer to advertise numerous products at once, giving the customer a more complete view of their inventory in the palm of their hand. Beginning with the customers' interest directed toward a single item upon entering the store, they are guided through multiple departments to multiple additional items, up-selling the in-store visit without the use of sales staff or sales techniques.

The ability to feature a wide range of products originating from the customers initial barcode scan acts as a handheld advertisement that is age, gender and categorically focused, directing them toward additional products so that the retailer can efficiently capitalize on each in-store visit.

Sharing the ‘Favorites’ list acts as additional, consumer generated, free advertising via Social Media platforms for the individual product and its brand, and the retailer as an identifiable brand.

‘Friend-to-friend’ advertising of individual products using Social Media encourages trans-global shopping using trans-global marketing, directing foreign traffic (customers who are unable to visit the brick and mortar location) to their online shopping site, in turn increasing online sales.

Using the system as an integrated advertising tool, the retailer can expand the melding of technology with retail using out-of-store advertisements, such as those found in print ads, and public billboard style ads such as those found on buses, subways or in the street. Equipped with a single barcode scanned by the consumer, each out-of-store ad will allow consumers to communicate with the retailer to obtain detailed product information and curated coordinating merchandise as they do in-store, encouraging a future shopping visit to the brick and mortar location, and furthering the retailers' advertising dollar.

FIG. 12 illustrates the CUSTOMER SERVICE LOCATOR: The ‘SH’ logo, utilized as a button to enable the ‘Customer Service Locator’ feature. ‘SH’ here stands for ‘Sales Help’ but is not limited to its use as a ‘Locator Button’ and may also be used as a logo independent of this feature.

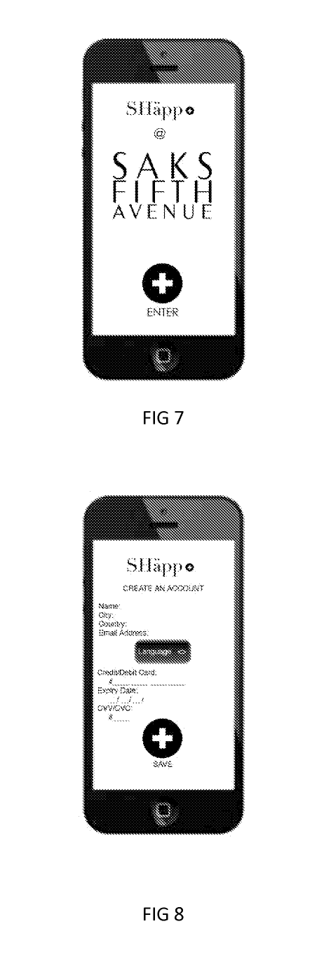

FIG. 7 illustrates a HOME SCREEN: The first screen that appears after opening the app, which is branded with the unique name and logo of the participating retailer.

FIG. 9 illustrates a SCAN SCREEN: Once the user touches the ‘ENTER’ button on the ‘Home’ Screen, they will be taken to the ‘Scan’ Screen, prompting them to scan the product barcode.

FIG. 10 illustrates an ITEM SCREEN: Following the scan of the product barcode, the system automatically directs the customer to a screen displaying the item just scanned [FIG. 10], with detailed product information, the ability to save the item in the ‘Favorites’ section and share it using various Social Media platforms using the system ‘plus’ icon, and the horizontal list of 9 curated items, shown 3 per scroll, that accompany and/or complement the initial product. Selecting one of the curated items opens a new screen [FIG. 13], displaying the newly selected item and a new set of 9 curated items below, and so and so forth. The customer has the ability to either scan the barcode of a new product using the ‘less than’ icon to return to the previous ‘Scan’ screen, or continue selecting to view coordinating products originating from their initial product barcode scan.

Advantages of the system to participating retailers and consumers include:
Directed and monitored up-selling via use of continuous cycle of items viewed and purchased in SHäpp™.
Greater Efficiency Turnover and Conversion ratios using guided marketing/advertising/shopping techniques through the mobile device.
Increased customer time spent within the brick and mortar location by directing customers to multiple departments within a single store location.
Increased advertising for each advertising dollar both in-store and out.
Data on customer habits, likes/dislikes as related to gender, age and location, email addresses, trend forecasting, advanced leanings toward product increase and/or decline.
Easy, enjoyable and efficient customer shopping experience.
Trans-global advertising and marketing via Social Media directing consumers to online shopping or in-store shopping, globally.
Integrated communication interface for fast and efficient payment using the mobile device.
Lower loss of sale (the average number of customers that enter the store/the average that exit without purchasing) ratio due to more efficient sales directed by corporate offices rather than the mood, skill set and motivation of sales associates.
Lower number of sales associates required for serving the customer—less expenditure for training and salary/wages.

The disclosed system provides the motivation for consumers to use their mobile device while shopping in-store—to provide detailed product information, fast, easy payment, suggested alternate products without the need of sales staff and to assist with the ease, efficiency and enjoyment of the overall shopping experience. The retailer is equally motivated to adopt the application and interface because it facilitates direct in-store communication with the consumer, provides up-to-date product knowledge, up-sells by suggesting a cycle of new items, and is a fast and easy in-store payment method that allows the customer to exit the store with their purchase in hand, as opposed to the current method of home delivery.

When used abroad, the system provides seamless retail-customer communication between travelers and retailers, assisting with the ease and efficiency of a foreign currency transaction by bypassing language barriers and confusion. The system bridges the communication gap using product information provided in the travelers' mother tongue, photos of item(s) to show sales associates if further assistance is needed and the ability to up-sell regardless of language spoken. Whether the traveler is from Europe or Asia where English is not the native language, shopping in North America or visa versa, The system allows effortless communication with and up-selling to the consumer regardless of their mother tongue or proficiency in English or foreign languages. Through Social Media platforms, travelers can notify friends and family ‘back home’ of their purchases, likes or dislikes, and gain the opinions of others thousands of miles away, furthering trans-global advertising and increasing online shopping traffic for those in foreign countries where the retailer is not located. In countries where the retailer has a brick and mortar location, trans-global advertising directs consumers to their local retail location with the photo and detailed information of the product they saw on Social Media in hand for fast and simple reference and payment.

System eliminates all of the variables noted above with current reliance on individual staff training to do up-selling, by imparting efficient sales techniques to the consumer that are created, directed and implemented at a corporate level, and communicated directly to the consumer within the retail location, and in real-time.

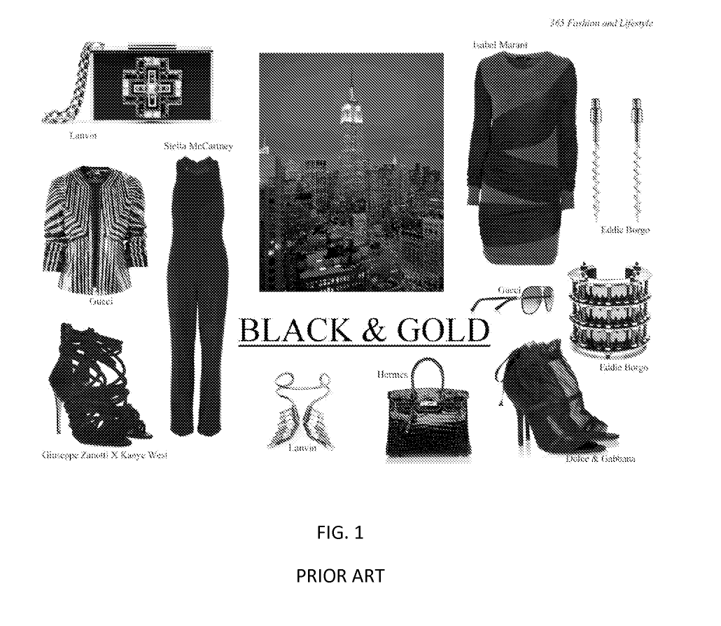

The system provides pre-determined, curated lists of items that are geared toward the age and gender of the consumer, while immediately and directly advertising items within multiple departments and categories to the consumer on the mobile device. Current practice is for retailers to create online catalogues or in the fashion sector, ‘look books’ [FIG. 1] displaying the ideal way to coordinate items, or possible add-on purchases to the original product of interest. However, ‘look books’ for example prove to be inefficient since they are photos of items that coordinate without providing the ability interact in-store. ‘Look books’ are presently located on online retail sites and through retail applications that are seldom used in-store—the consumer opts to physically look for matching items and ask for sales assistance, rather than open the retail application. The curated concept of the system disclosed herein draws from the established practice of ‘styling’, creating a hand held stylist, personal shopper and sales associate in one. Combined with its other features that facilitate in-store communication, the disclosed system effectively bridges the gap between the virtual and real shopping experience using the smartphone, enhancing retail efficiency, increasing sales, and creating an easy and enjoyable shopping experience for the customer.

While the principles of the invention have been shown and described in connection with specific embodiments, it is to be understood that such embodiments are by way of example and are not limiting. As is evident from the foregoing description, certain aspects of the present invention are not limited by the particular details of the mobile stand illustrated in the drawings. Other modifications and applications, or equivalents, will occur to those skilled in the art. The terms “having”, “comprising” and “including” and similar terms as used in the foregoing specification are used in the sense of “optional” or “may include” and not as “required”. Many changes, modifications, variations and other uses and applications of the present construction will, however, become apparent to those skilled in the art after considering the specification and attached drawings. All such changes, modifications, variations and other uses and applications which do not depart from the spirit and scope of the invention are deemed to be covered by the invention which is limited only by the claims that follow. The scope of the disclosure is not intended to be limited to the embodiments shown herein, but is to be accorded the full scope consistent with the claims, wherein reference to an element in the singular is not intended to mean “one and only one” unless specifically so stated, but rather one or more. All structural and functional equivalents to the elements of the embodiment described throughout the disclosure that are known or later come to be known to those of ordinary skill in the art are expressly incorporated herein by reference and intended to be encompassed by the claims.

1. A system to allow for a direct customer/retail integrated communication, the system comprising a handheld mobile computing and communication device, at least one retail store computer system capable of communicating with said handheld mobile computing and communication device, said handheld mobile computing and communication device having a graphic user interface display, scanner capability, a programmed computer processing means and means to communicate with the at least one retail store computer system, means activated through a product barcode scan on the handheld mobile computing and communication device, wherein the barcode scan is transmitted from the handheld mobile computing and communication device to the at least one retail store computer system and the at least one retail store computer system identifies and transmits to the handheld mobile computing and communication device photos, detailed product information and a plurality of alternate, upgraded, add-on and/or coordinating products, and wherein the photos, detailed product information and a plurality of alternate, upgraded, add-on and/or coordinating products are displayed graphic user interface display.

2. A method to allow for a direct customer/retail integrated communication, the method comprising providing software for download on a handheld mobile computing and communication device, said handheld mobile computing and communication device having a graphic user interface display, scanner capability, a programmed computer processing means and means to communicate with at least one retail store computer system, scanning a product barcode scan on the handheld mobile computing and communication device, transmitting the barcode scan from the handheld mobile computing and communication device to a retail store computer system, the retail store computer system identifying and transmitting to the handheld mobile computing and communication device photos, detailed product information and a plurality of alternate, upgraded, add-on and/or coordinating products, displaying the photos, detailed product information and a plurality of alternate, upgraded, add-on and/or coordinating products on the handheld device graphic user interface display.

3. A non-transitory computer readable storage medium having program instructions stored thereon for scanning a product barcode scan, transmitting the barcode scan from a handheld mobile computing and communication device to a retail store computer system, receiving from the retail store computer system photos, detailed product information and a plurality of alternate, upgraded, add-on and/or coordinating products, for displaying the photos, detailed product information and a plurality of alternate, upgraded, add-on and/or coordinating products on a graphic user interface display.
